(19) United States
(12) Patent Application Publication
(10) Pub. No.: US 2011/0011346 A1
(43) Pub. Date: Jan. 20, 2011

(54) Dual cat litter box

(76) Inventor: Allison Louise Crumpler, Mesa, AZ (US)

Correspondence Address: Allison Crumpler, 4147 N. Lomond St., Mesa, AZ, 85215, US

(21) Appl. No.: 12/460,444

(22) Filed: Jul. 20, 2009

(51) Int. Cl. A01K 29/00

(52) U.S. Cl. 119/165

(57) ABSTRACT

A Litter box having a removable top half and bottom half rectangle or square shaped. When top half and bottom half are engaged together produce two separate entrances into the cat litter boxes enclosure that the animal can go into the litter box. The litter box has a plastic molded divider in the middle bottom half of the litter box that reaches up to the top part of the top half that makes the separation into two separate litter box. When the removable top half litter box is placed on the bottom half litter box it creates two separate opening on the left and right side of the divider that makes two separate litter boxes within one unit.

### FIELD OF THE INVENTION

The present invention is related to a litter box more specifically the invention relates to a litter box which will cut down on the need for homes with multiple litter boxes.

### BACKGROUND OF THE INVENTION

Litter boxes for cats have been available for many years but clearly they are marketed for simplifying litter issues and single cat entry litter boxes. The present invention works for the need of households with multiple cats and the need for more than one litter box. The present invention will cut the need of multiple litter boxes and cutting down on the space that multiple litter boxes take up.

### SUMMARY OF THE INVENTION

The Inventor is owner of multiple cats and the need for more than one litter box is very common cats do not like sharing litter boxes. It is therefore an object of this invention to have two separate litter boxes in one unit the cats still feel like they have separate litter boxes. It is another object of the invention to cut down on the multiple litter boxes to one unit and to a desirable size still smaller than two big litter boxes. It is another object of the invention to minimize the space needed for homes with multiple litter boxes. It is another object of the invention to allow homes with multiple cats that don't like sharing one litter box this allows for cats to go into the litter box at the same time without sharing one box.

### DETAILED DESCRIPTION OF THE PERFERRED EMBOBIMENTS

The invention relates to a litter box which can be used for animals such as cats, more particularly the litter box has a built in divider in the bottom half of litter box which creates two separate litter boxes within one plastic molded rectangular or square shaped litter box.

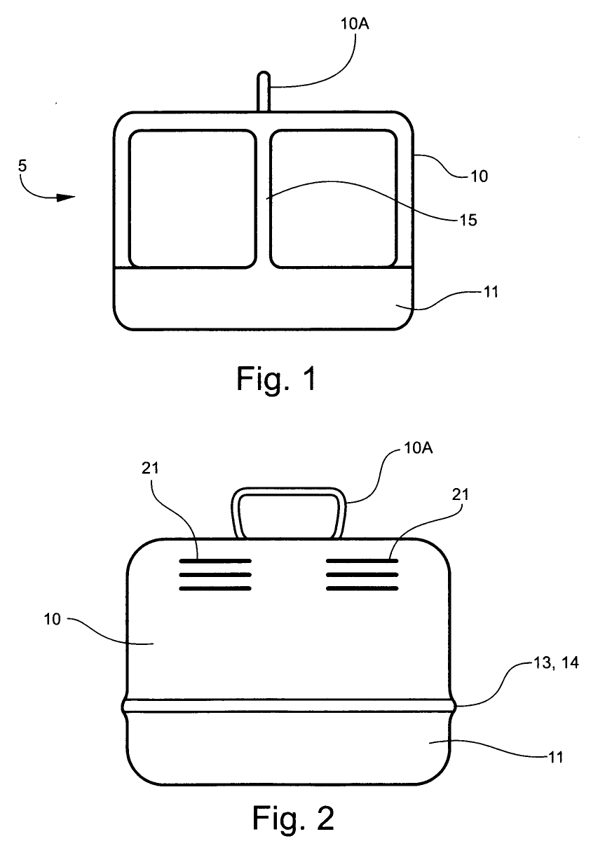

Referring to the drawings wherein like reference numbers refer to similar or identical parts throughout the views, more specifically to FIG. 1 there of, there is shown litter box 5 The litter box 5 comprising of a molded plastic rectangular or square shaped. When 10 is placed on 11 and 13 flange and 14 rest engage each other it becomes a litter box with two separate entrances with 15 being a plastic molded divider in 11 that makes the separation within the litter box.

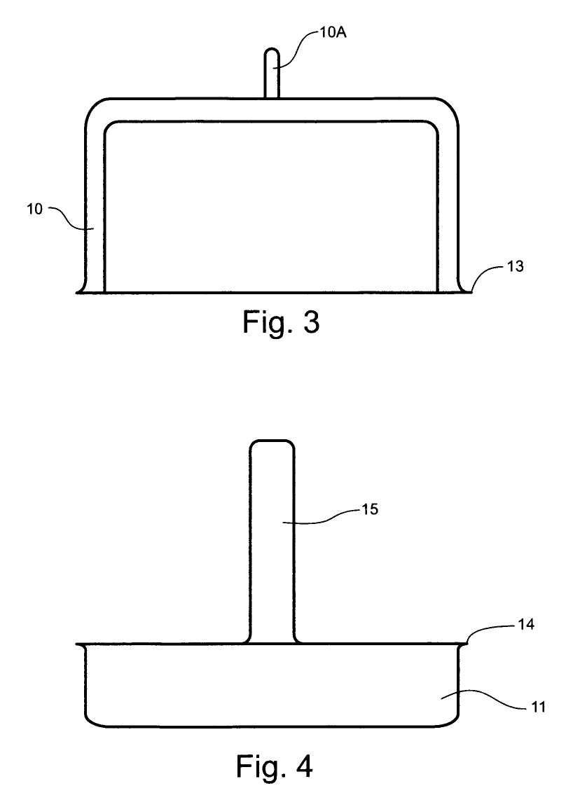

The operation procedure for the litter box 5 begins with placing the box halves 10 and 11 together with 11 being on the bottom with 15 in the middle of 11 on the floor surface facing in upward position (see FIG. 4) Next placing 10 in a downward position on top of 11 with the handle 10A. (See FIG. 3) 10 rests on 11 then is secured when 13 flanges engages with 14 rest making 10 and 11 a secure fit with two separate entrances into litter box 5.

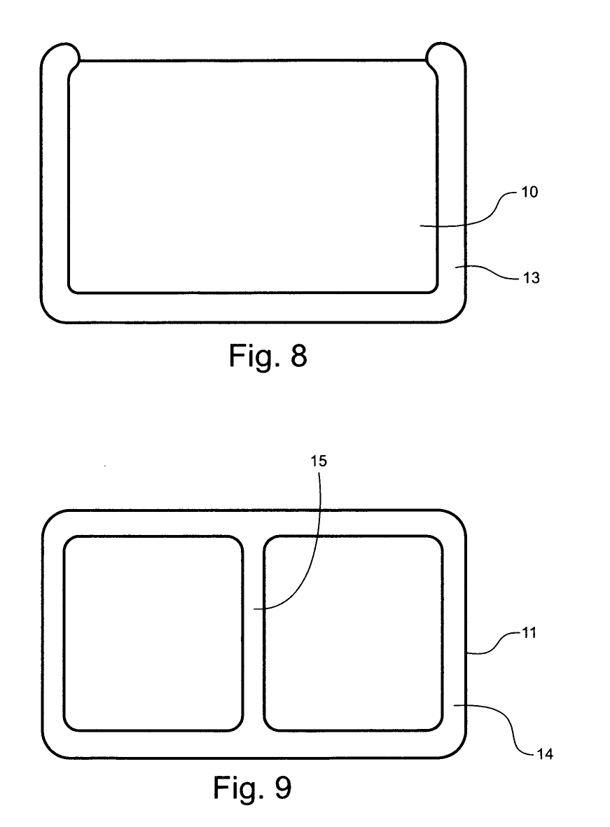

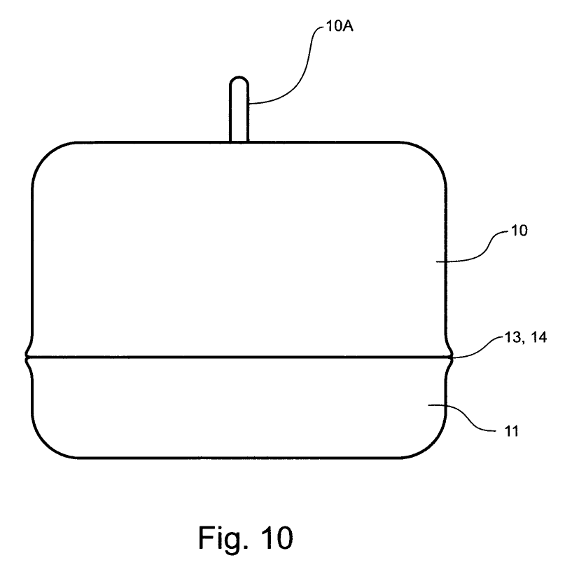

In FIG. 3 and FIG. 4 of litter box 5 with 15 plastic molded divider into 11 bottom half of litter box creates a separation in litter box 5 when 10 and 11 are placed together and 13 flange and 14 rest engage together that divides equally into two separate litter compartments for the litter and cat excrements. When 10 is placed on 11 (see FIG. 3 and FIG. 4) 15 divider of litter box 5 will be flush with the top inside roof wall of 10. With 15 being molded in plastic into the bottom tray of 11 that is ¼ inch thick that will be 18 inches tall that will set flush with upper top part of 10 when 10 is placed on 11 (FIG. 8 and FIG. 9)

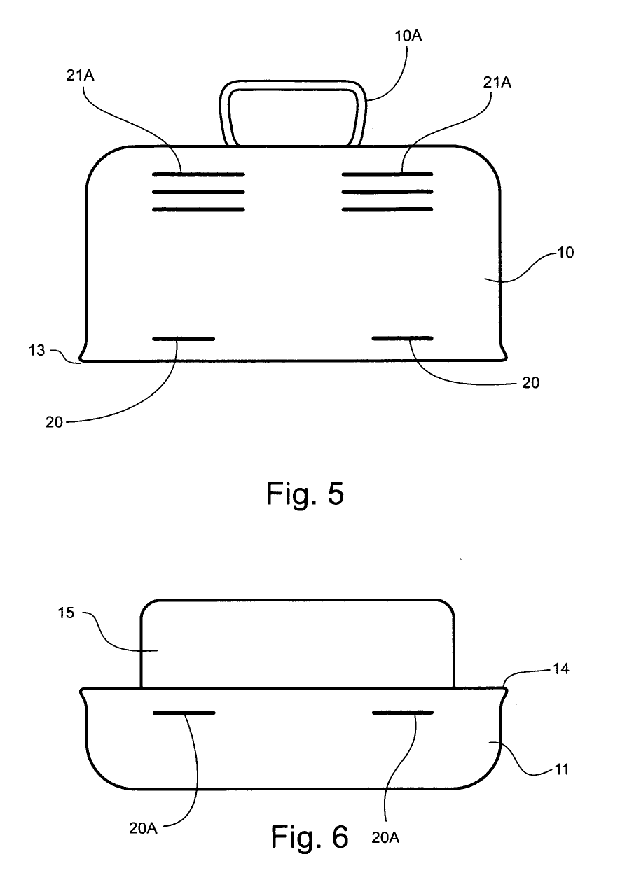

The litter box 5 has vents to be able to ventilate the litter box (see FIG. 5) is a side view of 10 with 21 and 21A being air vents to ventilate the litter box, on the left and right side of 10 of litter box 5 it will have a total of three openings in the upper left and three openings in upper right sides of 10 of litter box 5 for proper ventilating.

The following operation is preferred when the need arises to remove pet excrement and cleaning of litter box 5:

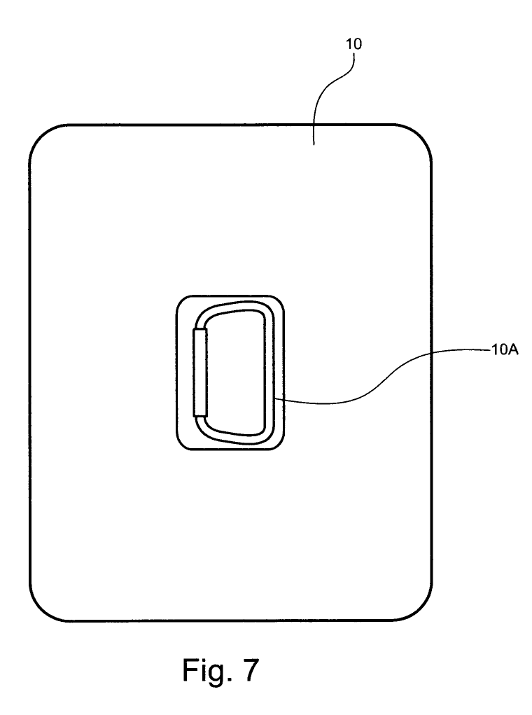

Remove the litter box half 10 which is the top half with 10A handle and set it a side leaving 11 or the bottom half of litter box open with two separate compartments for litter (see FIG. 3 and FIG. 4) making 10 a removable top half by using the handle 10A (see FIG. 7) making 11 two separate open areas with 15 being in the middle to enable proper cleaning and litter changing of litter boxes of the two separate compartments in litter box 5.

The litter box advantage in the market:

1. The litter box 5 saves on the use of multiple litter boxes in homes that need more than one litter box by condensing two litter boxes in one rectangular or square shaped box. Litter box 5 is a simpler unit in size and shape than having multiple litter boxes. Litter box 5 is unique to the market in the way it offers two litter boxes in one unit cats do not like sharing litter boxes with one another all the litters boxes today are single unit litter boxes.

The above present invention has been described for explanatory purposes it may be needed to those skilled in the manufacturing that variation can be made without departing from the scope of the invention except as it may be described by the following claims.

1. A litter box for a household with multiple cats comprising:
One box having two separate single litter box units the bottom half of litter box has a divider in the bottom half of the litter box that is plastic molded divider in from the bottom that reaches up to the top half of the litter box the top half of the litter box is made up of one removable unit that when the top part and the bottom part engage one another they form one single unit with two separate entrances that makes up one structure with two separate litter boxes

2. A litter box as described in claim 1 within said box are substantially square and rectangular in shape

3. A litter box as described in claim 2 when the top half of litter box and the bottom half of the litter box engage one another they make one unit with a divider in the middle the top half and bottom half of the litter box are both rectangle shaped when formed together

4. A litter box as described in claim 3 the divider in the bottom half of the litter box is ¼^{th} width that is molded in plastic and 18 inches tall the flushes with the top half of litter box when the top half is put on to engage the bottom part of the litter box

5. A litter box as described in claim 4 when the top half of litter box is engaged with the bottom half of litter box with the plastic molded divider in the middle of the bottom half of litter box this creates two separate individual opening into the litter box

6. A litter box as described in claim 5 wherein said openings are positioned on the left side and right side of the rectangular or square shaped litter box with the plastic molded divider on the bottom half of litter box when removable top half of litter box engages back on bottom half creates two litter spaces

7. A litter box as described in claim 6 where the top half of litter box is a movable lid

8. A litter box as described in claim 7 in making the top half of litter box movable it enables access for cleaning of litter box

9. A litter box as described in claim 3 the top part of the litter box has 1 inch flange and the bottom part of litter box has 1 inch rest so when the flange and rest meet they engage together interlocking top half of litter box and bottom half of litter box
